(19) United States
(12) Patent Application Publication
(10) Pub. No.: US 2014/0351699 A1
(43) Pub. Date: Nov. 27, 2014

(54) METHOD, DEVICE, AND MOBILE TERMINAL FOR PERFORMING A SHORT CUT BROWSER OPERATION

(71) Applicant: Tencent Technology (Shenzhen) Co., Ltd., Shenzhen (CN)

(72) Inventor: Wanxin Wang, Shenzhen (CN)

(21) Appl. No.: 14/336,674

(22) Filed: Jul. 21, 2014

Related U.S. Application Data
(63) Continuation of application No. PCT/CN2014/075914, filed on Apr. 22, 2014.

(30) Foreign Application Priority Data
May 22, 2013 (CN) 2013101926900

(51) Int. Cl. G06F 3/01; G06F 3/0484; G06F 3/0481

(52) U.S. Cl. CPC G06F 3/016; G06F 3/0481; G06F 3/0484
USPC 715/702

(57) ABSTRACT

The various disclosures disclose a method, device and mobile terminal for performing a short cut browser operation. The method including: detecting a shaking or rocking motion has been applied to a browser interface of a mobile terminal as an input control command; matching the applied shaking or rocking motion to a pre-determined motion table to correspond to the input control command on the browser interface; and upon a successful match, carrying out on the browser interface, an operation function corresponding to the input control command.

### CROSS-REFERENCE TO RELATED APPLICATIONS

The application is a continuation of PCT Application No. PCT/CN2014/075914, filed on Apr. 22, 2014, which claims priority to Chinese Patent Application No. 2013101926900, filed on May 22, 2013, which are incorporated by reference in their entireties.

### FIELD OF THE TECHNOLOGY

The present disclosure relates to the technical field of mobile terminal accessing Internet, and particularly to a method, a system and mobile terminal for performing a short cut browser operation.

### BACKGROUND

At present, launching a short cut operation on a web browser usually involves clicking on a relevant icon or function button on the mobile terminal display. However, such operation is still tedious and the efficiency may be quite low. Some similar operations may be carried out using voice commands in some terminals. Voice commands operations, nevertheless, are still quite limited and may suffer sensitivity issues in actual operations, thus may cause inconvenience to the user's experience.

### SUMMARY

The embodiments of the present disclosure disclose a method, device and mobile terminal for performing web browser short cut operations, which may improve operational efficiency on web browser launching and thus enhance user's experience.

In an embodiment, the present disclosure discloses a method for performing a short cut browser operation. The method including at least: detecting a shaking or rocking motion has been applied to a browser interface of a mobile terminal as an input control command; matching the applied shaking or rocking motion to a pre-determined motion table to correspond to the input control command on the browser interface; and upon a successful match, carrying out on the browser interface, an operation function corresponding to the input control command.

In another embodiment, the present disclosure discloses a device for performing a short cut browser operation. The device may include: at least a processor operating in conjunction with at least a memory which stores instruction codes operable as plurality of modules, wherein the plurality of modules may include: a detection module, which detects a shaking or rocking motion has been applied to a browser interface of a mobile terminal as an input control command; a matching module, which matches the applied shaking or rocking motion to a pre-determined motion table to correspond to the input control command on the browser interface; and an operation module, which upon a successful match, carries out on the browser interface, an operation function corresponding to the input control command.

Yet in another embodiment, the disclosure discloses a non-transitory computer-readable medium having stored thereon, a computer program having at least one code section being executable by a processor to perform a short cut browser operation in a mobile terminal, including: detecting a shaking or rocking motion has been applied to a browser interface of a mobile terminal as an input control command; matching the applied shaking or rocking motion to a pre-determined motion table to correspond to the input control command on the browser interface; and upon a successful match, carrying out on the browser interface, an operation function corresponding to the input control command.

### BRIEF DESCRIPTION OF THE DRAWINGS

The accompanying drawings are included to provide a further understanding of the claims and disclosure, are incorporated in, and constitute a part of this specification. The detailed description and illustrated embodiments described serve to explain the principles defined by the claims and may not be construed in a limited sense.

FIG. 1A depicts exemplary shaking or rocking motions applied to a mobile terminal which trigger short cut browser operation functions, according to an embodiment of the disclosure.

FIG. 1B is an exemplary flow chart illustrating a method for performing short cut browser operation on a mobile terminal, according to an embodiment of the disclosure.

FIG. 2A is an exemplary screen shot diagram of a browser interface of a mobile terminal, according to an embodiment of the disclosure.

FIG. 2B is another exemplary screen shot diagram of a browser interface of a mobile terminal, after completing an operation function corresponding to a shaking or rocking motion applied to the mobile terminal in FIG. 2A, according to an embodiment of the disclosure.

FIG. 3 is an exemplary flow chart illustrating a method for performing a shortcut browser operation in FIGS. 1A and 2A to 2B, according to an embodiment of the disclosure.

FIG. 4 is an exemplary flow chart illustrating a method for performing shortcut browser operation, according to another embodiment of the disclosure.

FIG. 5 is an exemplary structural diagram of a device for performing a shortcut browser operation, according to an embodiment of the disclosure.

FIG. 6 is an exemplary structural diagram of a device for performing a shortcut browser operation, according to another embodiment of the disclosure.

### DETAILED DESCRIPTION OF THE EMBODIMENTS

The various embodiments of the present disclosure are further described in details in combination with attached drawings and embodiments below. It should be understood that the specific embodiments described here are used only to explain the present disclosure, and are not used to limit the present disclosure. In addition, for the sake of keeping description brief and concise, the newly added features, or features that are different from those previously described in each new embodiment will be described in details. Similar features may be referenced back to the prior descriptions in a prior numbered drawing. Alternately, new features may be referenced ahead to a higher numbered drawing.

In order to clarify the objective, technical scheme and advantages of the present disclosure more specifically, the present disclosure is illustrated in further details with the accompanied drawings and embodiments. It should be understood that the embodiments described herein are merely examples to illustrate the present disclosure without limitations to their scope.

The various embodiments disclose a method, device and mobile terminal for performing a short cut browser operation. The method including: detecting a shaking or rocking motion has been applied to a browser interface of a mobile terminal as an input control command; matching the applied shaking or rocking motion to a pre-determined motion table to correspond to the input control command on the browser interface; and upon a successful match, carrying out on the browser interface, an operation function corresponding to the input control command. Accordingly, user's operations may be simplified.

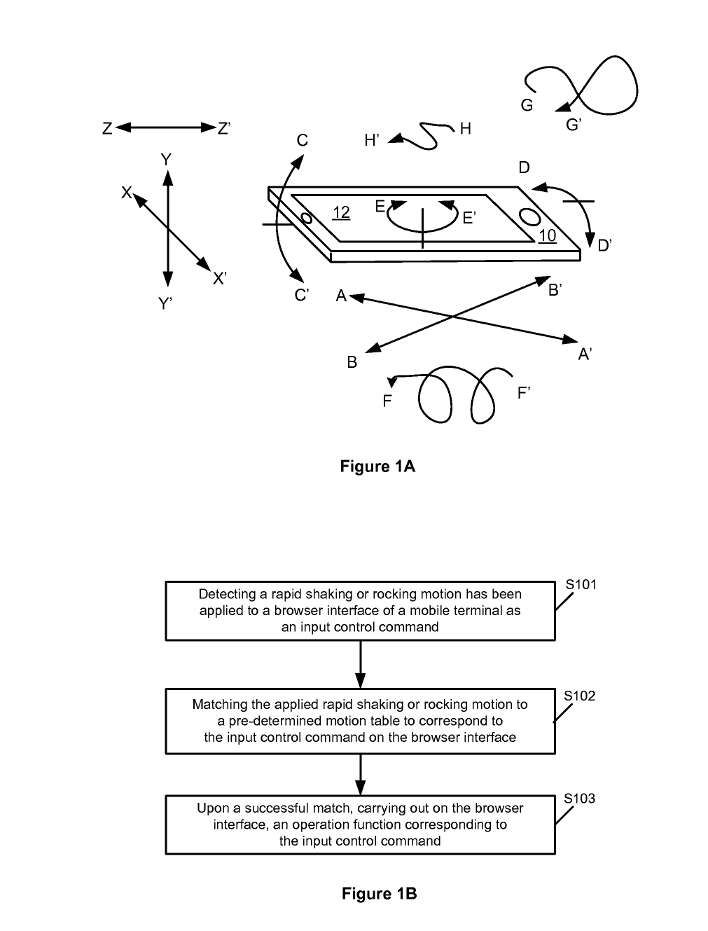

FIG. 1A depicts exemplary shaking or rocking motions applied to a mobile terminal (10) which may trigger short cut browser operation functions on a browser interface (12), according to an embodiment of the disclosure. For example, the various shaking or rocking motions may be listed as at least the following types:

Linear shaking motions: a user may apply respective linear shaking motions to the mobile terminal (10) by holding the mobile terminal (10) and shake along x, y and z axis in a linear fashion. For example, shaking motion may be applied along the left and right X-X′ horizontal direction, up and down Y-Y′ vertical direction, forward and backward Z-Z′ horizontal direction, and in diagonal A-A′, B-B′ horizontal directions. Each of the respective applied shaking motions may correspond to a respective input command to the browser interface (12), and consequently to carry out a respective operation function displayed on the browser interface (12). The applied shaking or rocking motions may be stored into a pre-determined motion table (204) as a database.

Rocking motions: a user may apply the following respective rocking motions to the mobile terminal (10) by rotating the mobile terminal (10) in different directions along different axis. For example, rocking motion by tilting the front part of the terminal up and down at an angle along the C-C′ direction. Rocking motion by rolling or rotating the mobile terminal (10) sideway clockwise and counterclockwise directions along the D-D′ direction. Rocking motion by yawing or rotating the mobile terminal (10) along the center in the E-E′ circular motion. Each of the respective applied rocking motions may correspond to a respective input command to the browser interface (12), and consequently to carry out a respective operation function displayed on the browser interface (12). The applied shaking or rocking motions may be stored into a pre-determined motion table (204) as a database.

Random motions: a user may apply the following random motions in any user defined pattern. For example, swivel motions zig-sagging the mobile terminal (10) along path H-H′. Corkscrew or spiral motion by spiraling the terminal along path F-F′. Random motion such as along a butterfly path G-G′. Each of the respective applied random motions may correspond to a respective input command to the browser interface (12), and consequently to carry out a respective operation function displayed on the browser interface (12). The applied shaking or rocking motions may be stored into a pre-determined motion table (204) as a database.

It should be pointed out that the disclosed applied shaking or rocking motions are not to be limited to the above described motions. The whole idea is that the traditional method of using touch screen to select a browser operation function may be replaced with shaking or rocking motion applied to the mobile terminal, which may be of some advantages to a user having physical handicap or to a user who may not be able to operate touch screen due to missing certain fingers on their hand to make the operation function selection.

In addition, since the applied shaking or rocking motions are customized or defined by the user, the pre-determined motion table (204) may also operate as a security lock to the mobile terminal, operable only by the owner of the mobile terminal (10) who creates the pre-determined motion table (204).

FIG. 1B is an exemplary flow chart illustrating a method for performing short cut browser operation on a mobile terminal (10), according to an embodiment of the disclosure. In view of the various shaking or rocking motion applied to the mobile terminal to perform short cut browser operations, the method may be further described with the following exemplary steps:

In step S101: detecting an indication that a shaking or rocking motion has been applied to a browser interface of a mobile terminal as an input control command. The input control command may include bookmarking 9 i.e., saving into bookmarks) a current web page, or opening a web page which is linked to a current web page as displayed on the browser interface (12), just to name a few. In this regard, a respective shaking or rocking motion applied to the mobile terminal (10) as described in FIG. 1A may correspond to a respective input control command to carry out the bookmarking of the current web page, or opening a link of a current web page. Thus eliminating the need of having to use the touch screen to select the respective operation function on the browser interface (12).

The mobile terminal (10) may be a smart phone, a notepad computing device, or any portable device which may be suitable for to carry out an applied shaking or rocking motion as input commands to the mobile terminal (10).

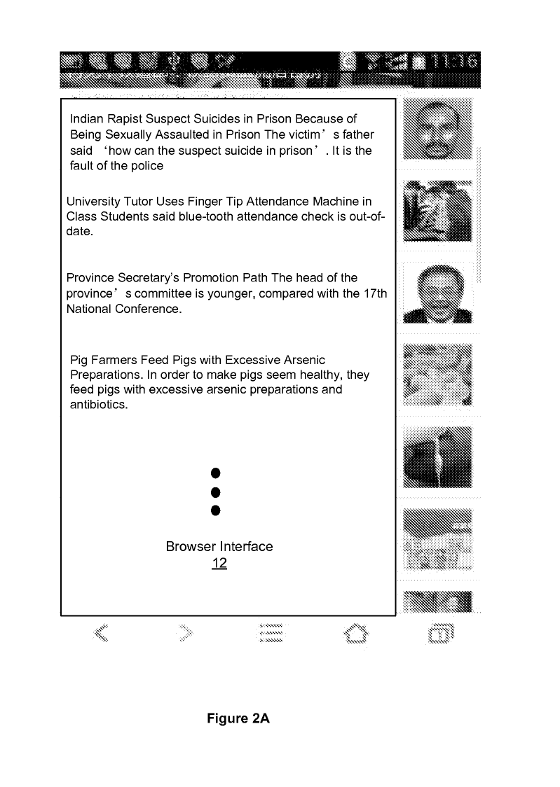

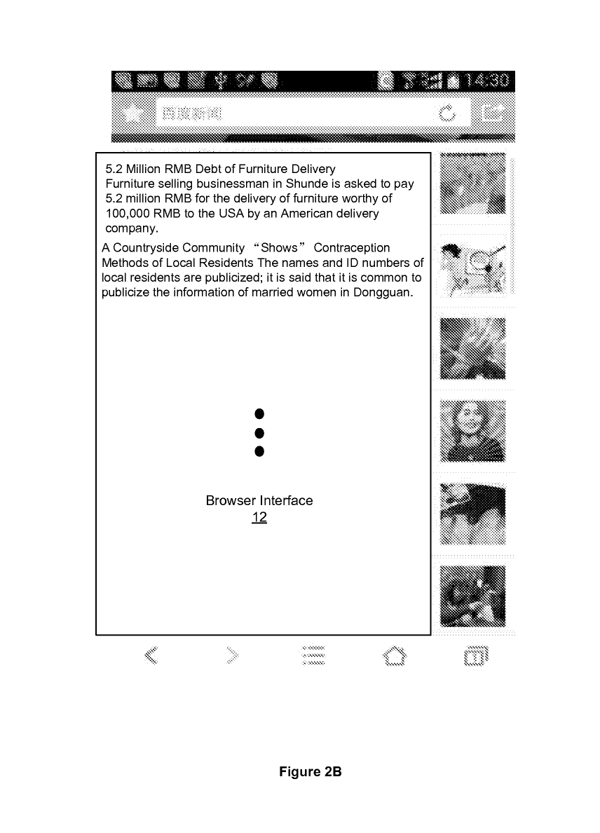

More specifically, in the beginning, when an applied shaking or rocking motion may be detected; a user may open and send corresponding input control commands to the browser interface (12) of the mobile terminal (10) through different respective applied shaking or rocking motion to the mobile terminal (10). For example, a user may bookmark a news web page (as shown in FIG. 2A) through a respective shaking or rocking motion applied to the mobile terminal.

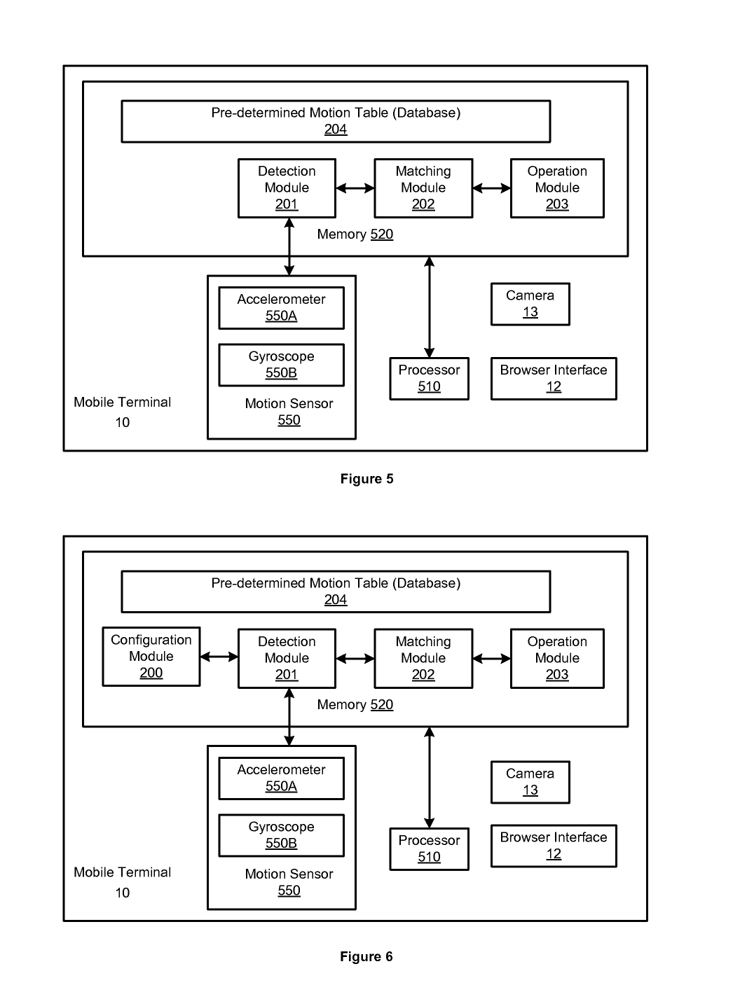

Through a sensor (such as sensor (550) in FIG. 5) on the mobile terminal (10), the mobile terminal (10) may sense a change of motion parameters in all three dimensions. More specifically, the change of motion parameters may include a change of acceleration, speed and displacement, which may be detected by an accelerometer (550A). The motion parameters may also include a change in directions or orientation, which may be detected by a gyroscope (550B) in the sensor (550), and so on. With the sensor (550), user's applied shaking and rocking motion to the mobile terminal (10) may be detected.

Specifically speaking, one or more of the three motion parameters, namely, acceleration, speed, displacement, and optionally orientation may form the standard parameters to correspond to motion data collection for the various respective input commands. And as to the three motion parameters mentioned above (i.e., acceleration, speed, displacement, and optionally orientation), a threshold value may be pre-set in the beginning. Afterwards, during the user's applied shaking or rocking motion operations, the mobile terminal (10) senses its own change of motion parameter in three dimensions (i.e., orientation parameter) through the sensor (550) on a mobile terminal (10). The three parameters (i.e., acceleration, speed, displacement) are collected in this way. If the parameters collected exceed a pre-defined threshold, the detection may indicate that this applied shaking or rocking motion operation may be valid; if not, this applied shaking or rocking motion operation may be invalid. The threshold helps to avoid miss-operation or unintended movement done to the mobile terminal (10), such as movements in the user's pocket, purse, computer case, etc.

It should be noted that the pre-defined threshold mentioned above may be a threshold of a single motion parameter or may be an integrated parameter threshold which may be acquired by calculating several motion parameters based on a summation calculation using contributions from all three motion parameters with weighing factors. Preferably, more than one motion parameters with weighing factors may be used to establish the pre-defined threshold to validate the applied shaking or rocking motions applied to the mobile terminal (10).

After the mobile terminal (10) has collected the measured motion parameters in three dimensions, a summation calculation on the current integrated motion parameters may be acquired. The current integrated motion parameter is compared with the pre-set or pre-defined parameter threshold in order to judge whether user's applied shaking or rocking motion operation may be valid or not.

The pre-set integrated motion parameter threshold above and the current integrated motion parameter may be acquired by employing summation above which may reflect the direction of shaking and track the path of the mobile terminal (10).

In another embodiment, the method may include: the mobile terminal (10) detecting user's applied shaking or rocking motion operation to the browser interface (12) of the mobile terminal (10) through a camera (13) of the mobile terminal (10). For instance, the user may control corresponding operation functions by shaking his or her both arms crossing each other to the left or right to the browser interface (12) of the mobile terminal (10) to simulate a motion.

In step S102: matching the applied shaking or rocking motion to a pre-determined motion table to correspond to the input control command on the browser interface. In the embodiment, the motion matching table (204) mentioned above is pre-determined; which the various shaking or rocking motions or gestures may be pre-set by the user in advance, as previously described in FIG. 1A. Each type of shaking or rocking motion may correspond to a respective operation function to the browser interface (12). The various shaking or rocking motion which are pre-set or predetermined by the user to correspond to the operation function to the browser interface may be saved ahead of time, as defined by the user as described in FIG. 1A. Consequently, a predetermined motion table (204) may be established and saved as a database for matching to a corresponding operation.

After the browser interface (12) has detected a user's applied shaking or rocking motion, the detected shaking or rocking motion (via the sensor 550) may be is searched by the pre-determined motion table (204). If an operation function corresponding to the applied shaking or rocking motion is found in pre-determined motion table (204), matching is successful; if not, matching fails.

In step S103: upon a successful match, carrying out on the browser interface, an operation function corresponding to the input control command. The operation function to be carried out by the browser interface may be booking a current page operation, upon a successful matching. If matching fails, there will be no further operation, and a notice may be sent to notify the user that no matching is found.

FIG. 2A is an exemplary screen shot diagram of a browser interface (12) of a mobile terminal (10), according to an embodiment of the disclosure. More specifically, FIG. 2A illustrates that a bookmarking operation is to be performed on the entire current web page news,

As may be seen from FIG. 2A, various titles of information bar may be displayed in the browser interface (24). If the user wants to save the current interface web page as a as bookmark such that the same web page may be quickly opened by the browser interface (12) next time, the user may only do so by applying a shaking or rocking motion to the mobile terminal (10) according to the corresponding input command in the pre-determined motion table (204).

FIG. 2B is another exemplary screen shot diagram of a browser interface (12) of a mobile terminal (10), after completing the operation function corresponding to a shaking or rocking motion applied to the mobile terminal (10) in FIG. 2A, according to an embodiment of the disclosure.

More specifically, FIG. 2B illustrates that by applying a shaking or rocking motion to the browser interface (12) of the mobile terminal (10), another operation function, such as opening a web page from a stored bookmark, or opening a link to the current web page of FIG. 2A may be performed, upon a successful matching of the respective applied shaking or rocking motion.

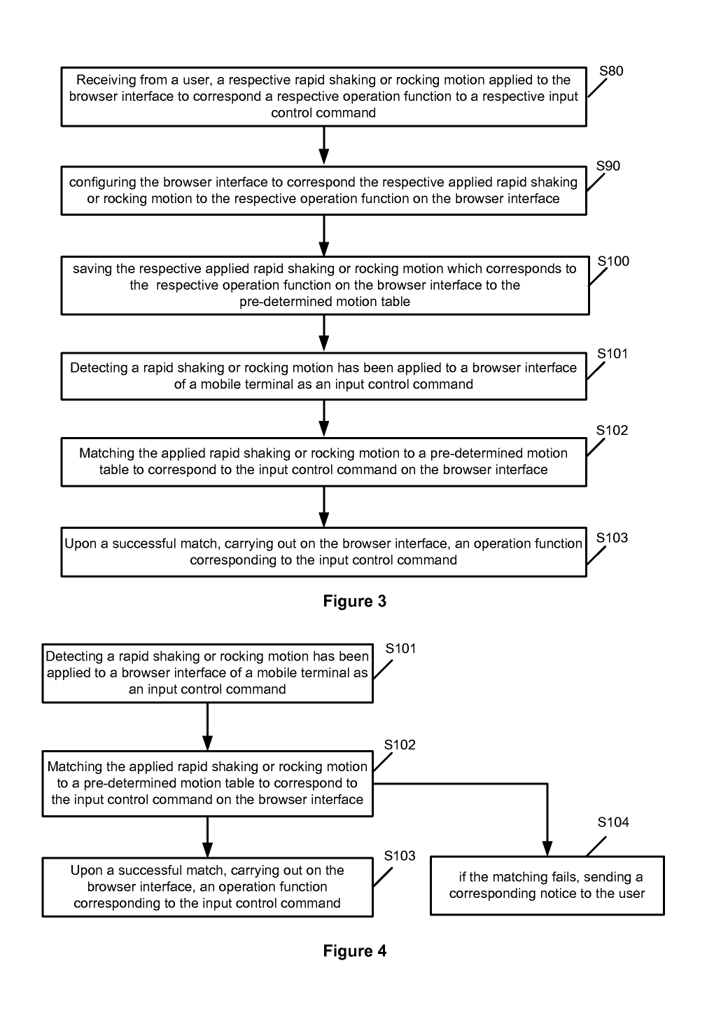

FIG. 3 is an exemplary flow chart illustrating a method for performing a shortcut browser operation in FIGS. 1A and 2A to 2B, according to an embodiment of the disclosure. The method may include at least the following exemplary steps. As may be seen, the flow chart of FIG. 3 is identical to FIG. 1B, except the operations prior to step S101, namely, prior to the detecting of the shaking or rocking motion has been applied to the browser interface (12) of the mobile terminal (10) as the input control command. The prior steps may include the following:

Step S80: receiving from a user, a respective shaking or rocking motion applied to the browser interface (12) to correspond a respective operation function to a respective input control command.

Step S90: configuring the browser interface (12) to correspond the respective applied shaking or rocking motion to the respective operation function on the browser interface (12).

Step S100: saving the respective applied shaking or rocking motion which corresponds to the respective operation function on the browser interface (12) to the pre-determined motion table (204).

In effect, FIG. 3 discloses a scheme of the generating or the creating of the pre-determined motion matching table (204) which is saved into the memory (520) as a database. A user may pre-define his or her respective applied shaking or rocking motion to correspond to which input commands on the browser interface (12). As a result the browser interface (12) may consequently perform the respective operation functions through matching the respective applied shaking or rocking motion to correspond to the respective input commands listed in the pre-determined motion matching table (204).

FIG. 4 is an exemplary flow chart illustrating a method for performing shortcut browser operation, according to another embodiment of the disclosure. As may be seen, FIG. 4 is identical to FIG. 1B, except with another outcome after step S102. Namely, step S104: a notice may be sent by the Operation Module to notify or remind the user that matching has failed.

FIG. 5 is an exemplary structural diagram of a device for performing a shortcut browser operation, according to an embodiment of the disclosure. In an embodiment of the disclosure, the device may be the mobile terminal (10). The device may include at least a processor (510) operating in conjunction with at least a memory (520) which stores instruction codes operable as plurality of modules, wherein the plurality of modules may include:

a detection module (201), which detects a shaking or rocking motion which has been applied to a browser interface (12) of a mobile terminal (10) as an input control command;

a matching module (202), which matches the applied shaking or rocking motion to a pre-determined motion table (204) to correspond to the input control command on the browser interface (12). If the respective operation function corresponding to the applied rapid shaking or rocking motion in the pre-determined motion table is found, the matching is successful, otherwise, the matching fails. If the matching fails, sending a corresponding notice to the user; and an operation module (203), which upon a successful match, carries out on the browser interface (12), an operation function corresponding to the input control command.

In the embodiment, the relevant operation functions (such as bookmarking a current web page and opening setting web page of the browser, and so on.) of the browser interface (12) of a mobile terminal (10) may be controlled by the user's applied shaking or rocking motion operation in order to improve the convenience of operation in the browser for the user.

The mobile terminal (10) mentioned previously may be mobile phone and tablets and so on. The user's shaking operation may be shaking or waggling the mobile terminal (10).

In addition, the device (10) may also include a sensor (550), which may further include at least an accelerometer (550A) and a gyroscope (550B). The accelerometer (550A) may detect a magnitude of acceleration in all directions (generally in three axes of x, y and z directions) and may detect the magnitude and direction of gravity in static condition. The motion sensor (550) may be configured to recognize movement or gesture applications to the mobile phone (10) (such as screen rotation, related games, posture calibration with a magnetometer), or vibration recognition related functions (such as pedometer, knocking), etc. More specifically, the accelerometer may measure the motion (acceleration, speed, displacement) parameters in three dimensions.

The gyroscope (550B) may sense axis orientation, measure the change of orientation (x, y, z and rotational axis). The above description is for exemplary understanding of their applications to the generation of pre-determined motion matching table (204) and the establishing of a threshold to detect a valid user applied shaking or rocking motion. It is beyond to scope of this disclosure to go into much detail.

It should be noted that the threshold mentioned above may be the threshold of a single motion parameter or may be an integrated parameter threshold which is acquired by calculating several parameters based on a summation calculation with weighing factor; the preferred method of implementation is the latter one mentioned above.

After the mobile terminal (10) collected motion parameters of three dimensions, by employing the same summation calculation above, the current integrated motion parameter is acquired. The current integrated motion parameter is compared with the pre-set parameter threshold in order to judge whether the user's order of motion operation is valid or not.

The pre-set integrated parameter threshold above and the current integrated motion parameter which is acquired by employing summation calculation above may reflect the shaking direction and track of the mobile terminal (10).

In addition, another method of implementation may include the mobile terminal (10) detecting user's applied shaking or rocking motion to the browser interface (12) of the mobile terminal (10) through a camera (13) on the mobile terminal (10). For instance, the user may control corresponding operation functions by shaking his or her both arms crossing each other to the left or right to the browser interface (12) of the mobile terminal (10) to simulate a motion.

FIG. 6 is an exemplary structural diagram of a device for performing a shortcut browser operation, according to another embodiment of the disclosure. As may be seen, FIG. 6 and FIG. 5 are highly similar, except with an additional configuration module (200).

The configuration module (200) may perform functions, which include: receiving from a user, a respective rapid shaking or rocking motion applied to the browser interface (12) to correspond a respective operation function to a respective input control command; configuring the browser interface (12) to correspond the respective applied rapid shaking or rocking motion to the respective operation function on the browser interface; and saving the respective applied rapid shaking or rocking motion which corresponds to the respective operation function on the browser interface to the pre-determined motion table (204). In effect, the difference between FIGS. 5 and 6 lies on the scheme of generating or creating of the predetermined motion matching table (204), which is stored into the memory (520) as a database.

The steps in the various methods in the aforementioned embodiments may be completed via programs, which command corresponding hardware. Such programs may be stored in a non-transitory computer-readable memory medium. The memory medium may include: flash memory disk, read-only memory (ROM), random access memory (RAM), disk or compact disk, etc.

Disclosed above are only preferred embodiments of the present disclosure and these preferred embodiments are not intended to be limiting the scope of rights of the present disclosure, hence any equivalent changes made according to the claims of the present disclosure shall fall within the scope of the present disclosure.

What is claimed is:

1. A method for performing a short cut browser operation, comprising:
detecting a shaking or rocking motion has been applied to a browser interface of a mobile terminal as an input control command;
matching the applied shaking or rocking motion to a pre-determined motion table to correspond to the input control command on the browser interface; and
upon a successful match, carrying out on the browser interface, an operation function corresponding to the input control command.

2. The method according to claim 1, wherein prior to the detecting of the shaking or rocking motion has been applied to the browser interface of the mobile terminal as the input control command, the method comprises:
receiving from a user, a respective shaking or rocking motion applied to the browser interface to correspond a respective operation function to a respective input control command;
configuring the browser interface to correspond the respective applied shaking or rocking motion to the respective operation function on the browser interface; and
saving the respective applied shaking or rocking motion which corresponds to the respective operation function on the browser interface to the pre-determined motion table.

3. The method according to claim 2, wherein the matching of the applied shaking or rocking motion to the pre-determined motion table to correspond to the input control command on the browser interface, comprises:
searching the respective operation function corresponding to the applied shaking or rocking motion in the pre-determined motion table; and
if the respective operation function corresponding to the applied shaking or rocking motion in the pre-determined motion table is found, the matching is successful, otherwise, the matching fails.

4. The method according to claim 3, further comprising:
if the matching fails, sending a corresponding notice to the user.

5. The method according to claim 1, wherein the browser operation function comprises at least bookmarking a current browser webpage or opening a browser web page.

6. A device for performing a short cut browser operation, comprising at least a processor operating in conjunction with at least a memory which stores instruction codes operable as plurality of modules, wherein the plurality of modules comprise:
a detection module, which detects a shaking or rocking motion has been applied to a browser interface of a mobile terminal as an input control command;
a matching module, which matches the applied shaking or rocking motion to a pre-determined motion table to correspond to the input control command on the browser interface; and
an operation module, which upon a successful match, carries out on the browser interface, an operation function corresponding to the input control command.

7. The device according to claim 6, further comprising:
a configuration module, which:
receives from a user, a respective shaking or rocking motion applied to the browser interface to correspond a respective operation function to a respective input control command;
configures the browser interface to correspond the respective applied shaking or rocking motion to the respective operation function on the browser interface; and
saves the respective applied shaking or rocking motion which corresponds to the respective operation function on the browser interface to the pre-determined motion table.

8. The device according to claim 7, wherein the matching module is further configured to search the respective operation function corresponding to the applied shaking or rocking motion in the pre-determined motion table; if the respective operation function corresponding to the applied shaking or rocking motion in the pre-determined motion table is found, the matching is successful, otherwise, the matching fails.

9. The device according to claim 8, wherein if the matching fails, sending a corresponding notice to the user.

10. The device according to claim 6, wherein the browser operation function comprises at least bookmarking a current browser webpage or opening a browser web page.

11. A non-transitory computer-readable medium having stored thereon, a computer program having at least one code section being executable by a processor to perform a short cut browser operation in a mobile terminal, comprising:
detecting a shaking or rocking motion has been applied to a browser interface of a mobile terminal as an input control command;
matching the applied shaking or rocking motion to a pre-determined motion table to correspond to the input control command on the browser interface; and
upon a successful match, carrying out on the browser interface, an operation function corresponding to the input control command.

12. The non-transitory computer-readable medium according to claim 11, wherein prior to the detecting of the shaking or rocking motion has been applied to the browser interface of the mobile terminal as the input control command, the method comprises:
receiving from a user, a respective shaking or rocking motion applied to the browser interface to correspond a respective operation function to a respective input control command;
configuring the browser interface to correspond the respective applied shaking or rocking motion to the respective operation function on the browser interface; and
saving the respective applied shaking or rocking motion which corresponds to the respective operation function on the browser interface to the pre-determined motion table.

13. The non-transitory computer-readable medium according to claim 12, wherein the matching of the applied shaking or rocking motion to the pre-determined motion table to correspond to the input control command on the browser interface, comprises:
searching the respective operation function corresponding to the applied shaking or rocking motion in the pre-determined motion table; and
if the respective operation function corresponding to the applied shaking or rocking motion in the pre-determined motion table is found, the matching is successful, otherwise, the matching fails.

14. The non-transitory computer-readable medium according to claim 13, further comprising:
if the matching fails, sending a corresponding notice to the user.

15. The non-transitory computer-readable medium according to claim 11, wherein the browser operation function comprises at least bookmarking a current browser webpage or opening a browser web page.
